(19) United States
(12) Patent Application Publication
(10) Pub. No.: US 2025/0316021 A1
(43) Pub. Date: Oct. 9, 2025

(54) 3D RECONSTRUCTION METHOD AND PICTURE RECORDING ARRANGEMENT

(71) Applicant: ams-OSRAM AG, Premstätten (AT)

(72) Inventors: Enrico Cortese, Paris (FR); Josselin Manceau, Bagneux (FR); Matis Hudon, Charenton-le-pont (FR); Guillaume Cortes, Villeurbanne (FR)

(21) Appl. No.: 18/865,960

(22) PCT Filed: May 10, 2023
(86) PCT No.: PCT/EP2023/062446

§ 371 Date: Nov. 14, 2024

(30) Foreign Application Priority Data
Jun. 3, 2022 (DE) 10 2022 114 112.8

(51) Int. Cl. G06T 17/00; G06V 10/141; G06V 10/143

(52) U.S. Cl. CPC G06T 17/00; G06V 10/141; G06V 10/143

(57) ABSTRACT

In at least one embodiment, a method for 3D reconstruction of a target includes providing a picture recording arrangement comprising an image sensor and a light source, the light source being configured to illuminate the target along different emission directions, taking a plurality of measurement pictures along the emission directions, wherein, per measurement picture, only a subset of the emission directions is served by the light source and reconstructing a three-dimensional shape of the target from the measurement pictures, wherein taking the plurality of measurement pictures comprises illuminating the target in an indirect manner so that at least some of the emission directions point next to the target and not onto the target, and wherein orientations of the emission directions relative to the image sensor are fixed.

### CROSS-REFERENCE TO RELATED APPLICATIONS

This patent application is a national phase filing under section 371 of PCT/EP2023/062446, filed May 10, 2023, which claims the priority of German patent application 102022114112.8, filed Jun. 3, 2022, each of which is incorporated herein by reference in its entirety.

### TECHNICAL FIELD

A method for 3D reconstruction and a picture recording arrangement are provided.

### BACKGROUND

Document Daniel Lichy et al., “Shape and Material Capture at Home”, arXiv:2104.06397v1 [cs.CV], Apr. 13, 2021, refers to 3D reconstruction of objects.

### SUMMARY

Embodiments provide a picture recording arrangement and a corresponding method for simplified 3D reconstruction of a target.

With the method and the picture recording arrangement described herein, for example, a target is indirectly illuminated from different directions and a series of corresponding measurement pictures is taken. From these measurement pictures, a 3D shape of the target, also referred to as object, is reconstructed. Thus, 3D reconstruction can be done in a simplified manner by, for example, a mobile device, like a smart phone.

According to at least one embodiment, the method is for 3D reconstruction. For example, by the method adjustable indirect illumination conditions are provided so that a target can be illuminated from different directions to achieve the 3D reconstruction.

According to at least one embodiment, the method includes the step of providing a picture recording arrangement. The picture recording arrangement comprises one or a plurality of image sensors, like CCD sensors. Further, the picture recording arrangement comprises one or a plurality of light sources, like an LED light source. The at least one light source is configured to illuminate a scene comprising a target to be photographed while lit along different emission directions. In other words, the at least one light source is configured to provide a plurality of illuminated areas, for example, in surroundings of the target.

The term ‘light source’ may refer to visible light, like white light or red, green and/or blue light, but can also include infrared radiation, for example, near-infrared radiation in the spectral range from 750 nm to 1.2 μm. That is, along each emission direction visible light and/or infrared radiation can be emitted.

According to at least one embodiment, the method includes the step of taking at least one measurement picture for a selection of the emission directions or for each one of the emission directions, wherein per measurement picture the light source emits radiation only along a subset of the emission directions. The measurement pictures can be taken by visible light or also by using infrared radiation. During this method step, preferably the picture recording arrangement, in particular the image sensor, does not move or does not move intentionally. The emission directions are different from each other in pairs so that there are no emission directions being parallel or congruent with each other.

For example, N measurement pictures are taken for the M emission directions, wherein N and M are natural numbers, for example, larger than or equal to two or larger than or equal to six or larger than or equal to ten. Alternatively or additionally, N and M are smaller than or equal to 40 or smaller than or equal to 30 or smaller than or equal to 20. It is possible that N=M, but it is also possible that |M-N|≠0, for example, 0<|M-N|≤3 or 0<|M-N|≤0.25 max {M; N} or 0<|M-N|≤max {M; N}.

For example, the subset of emission directions consists in each case of one of the emission directions. However, it is also possible that the subset of emission directions includes more than one of the emission directions, for example, two or three or four of the emission directions. It is possible that all the measurement pictures are taken with the same number of emission directions activated, that is, with subsets of equal size, or that the measurement pictures are taken with different number of activated directions, that is, with subsets of different sizes.

However, preferably, N=M, and there are M linear independent subsets of emission directions, and there is one or there are two emission directions per subset, and all the subsets are of equal size, that is, comprising the same number of emission directions.

According to at least one embodiment, the method includes the step of reconstructing a three-dimensional shape of the target from the measurement pictures. That is, the measurement pictures taken with different illumination conditions are a basis for the 3D reconstruction.

In at least one embodiment, the method is for adapting illumination and comprises the following steps, for example, in the stated order:
A) Providing a picture recording arrangement comprising an image sensor (2) and a light source, the light source is configured to illuminate the target along different emission directions,
B) Taking a plurality of measurement pictures along the emission directions, wherein per measurement picture only a subset of the emission directions is served by the light source, and
C) Reconstructing a three-dimensional shape of the target from the measurement pictures.

In other words, for example, a method is provided to drive a system to acquire illumination-varying images for 3D reconstruction.

Recovering the shape and material of an object is a long-studied problem in Computer Vision and Graphics. The research around this field focuses on two main tracks, in particular:
Using a set of images captured from different viewpoints, also referred to as multi-view Stereo;
Using a set of images from a single viewpoint with different light directions and intensities, also referred to as photometric stereo.

While both solutions accomplish the same goal, photometric stereo solutions are excellent at recovering fine details.

However, one drawback of the current photometric stereo based solutions is the data capture process. Usually, this kind of solutions requires a setup with a huge number of light sources placed around the object to be captured, and they require some tedious calibration steps for both the lights and the cameras involved. Some solutions were able to overcome these limitations using fewer light sources and no calibration step, but even in those cases the acquisition is still time-consuming for the user. Such methods require, for example, a tripod and a remote trigger to control the camera, need a user to move around the object with an external light source and to capture a huge number of pictures.

The method described herein fits into the photometric stereo field and aims at easing the image acquisition process. The picture recording arrangement thus comprises a camera, that is, the image sensor, and multiple flashes, that is, the light source capable of emitting along the emission directions, close to the camera, pointing outside the field of view of the camera. The bouncing lights are used to capture images with different light directions. Having multiple flashes placed in the same positions, but with different orientations indirectly lighting the object, allows this solution to provide the right inputs to solve the photometric stereo problem with a compact and single handheld device, without the need of any external light sources. This allows a non-professional user to reconstruct high-quality shape and reflectance of an object in virtually no-time, just with one click.

The method described herein makes use, for example, of multiple flashes embedded in an image capturing device, like a smart phone or a standalone camera. The flashes preferably point outside the camera field of view, and need to be interfaced with the device so that the user can control every single source of light separately, and trigger them one by one.

Using these multiple flashes, for example, the system takes one image per source of light, sequentially turning them on and off, to obtain images with varying illumination directions. No external light sources or remote triggers are involved, but only a capturing device with this multi-flash light source embedded.

After obtaining the different input images, that is, the measurement pictures, any photometric stereo based solution to recover the normal maps and the albedo of the target that is being captured can be run. Preferably, a solution is used that does not require any calibration of the lights, like in document Daniel Lichy et al., “Shape and Material Capture at Home”, arXiv:2104.06397v1 [cs.CV], Apr. 13, 2021, wherein the disclosure content of this document is incorporated herein by reference in its entirety.

But even in the case of some calibration steps involved, having the light position, direction and intensities fixed significantly facilitates the process.

Preferably, low-light conditions, like a darkroom, are present to obtain the input images in order for the light source to have a visible and clear impact on the shading of the object in the captured images. Moreover, since the lights are pointed sideways, it's preferred to have some nearby bouncing surfaces, like near walls or a large box, where to place the object, to make the light bounce back inside the field of view.

Concerning the method described herein, one difference with existing solutions is the compactness and slenderness of the method, allowing non-professional users to reconstruct their objects in household settings with just one click and no other external tools or devices.

Furthermore, the associated picture recording apparatus is not only more compact, but also much faster. In particular, no or only a minimum calibration step is required. In the method described herein, it is possible with a single click that the user can have the input images in a few seconds.

Thus, one preferred embodiment of the method described herein can be summarized as follows:
Having multiple flashes, arranged in a way that light-emitting units of the light source are almost in the same position, but with different orientations of the respective emission directions;
using bouncing light instead of direct light which points at the object or scene, wherein for an additional measurement picture optionally direct lighting can be used; and
embedding the multiple flashes in the image capturing device to have a unique and compact tool.

However, some variations could be made:
Have the multiple bouncing flashes and the camera separated one from the other in two different tools.
Add a direct flash to the picture recording apparatus used to acquire the input images.
Use a single device with both a camera and multiple flashes surrounding the camera, but with the flashes pointing towards the scene and not outside the field of view.
Use one single LED that can be moved and placed at different positions and orientations. This requires having some small arm where to attach the LED and some sort of servo motor to rotate and control the arm.

According to at least one embodiment, in step B) the target is illuminated in an indirect manner so that all or some or a majority of the emission directions point next to the target. In other words, all or some or a majority of the emission directions do not point onto the target.

According to at least one embodiment, in step B) the target is illuminated in part in a direct manner so that one or some of additional emission directions point onto the target.

According to at least one embodiment, orientations of the light source's emission directions relative to the image sensor are fixed. That is, the emission directions do not vary their orientation relative to one another and relative to the image sensor. This is true in particular in method step B).

According to at least one embodiment, the 3D reconstruction is based on the stack of measurement pictures taken with indirect light, and also with an additional measurement picture taken with direct light. That is, in particular one image of the overall input stack of images can be an image captured with a direct flash.

According to at least one embodiment, a diameter of the light source is at most 0.3 m or is at most 0.2 m or is at most 8 cm or is at most 4 cm, seen in top view of the image sensor. Thus, the light source has, for example, lateral dimensions smaller than that of a mobile phone.

According to at least one embodiment, in step B) for each one of the emission directions exactly one measurement picture is taken, and per measurement picture exactly one of the emission directions is served by the light source. Thus, there is the same number of emission directions and measurement pictures, or there are p times as many measurement pictures than emission directions wherein p is a natural number greater than one and smaller than or equal to six. In particular, p=3 when red, green and blue light is used.

According to at least one embodiment, for at least one or for some or for all of the emission directions, more than one measurement picture is taken, wherein these measurement pictures differ from one another, for example, in the intensity of illumination along the respective emission direction. That is, intensity is varied and for the respective at least one emission direction different intensities are applied. Accordingly, the above-mentioned factor p can be larger than 3. If for only some of the emission directions the intensity is varied, or if not for all the emission direction the same number of measurement pictures is taken, p may not be a natural number but a rational number.

According to at least one embodiment, step B) is done under low-light conditions so that there is no illumination source to illuminate the target despite the light source of the picture recording arrangement. For example, low-light conditions may mean that an irradiance onto the target is at most 10 W/m² or is at most 1 W/m² or is at most 0.1 W/m², when the light source is turned off. It is also possible that step B) is done in dark room conditions, so that the external irradiance onto the target is at most 10 mW/m² or is at most 1 mW/m² or is at most 0.1 mW/m².

According to at least one embodiment, step B) is done while the target is illuminated by at least one exterior illumination source, like a luminaire. Said illumination can be direct light or indirect light. Said illumination can be comparably weak so that the target may not be in bright light.

According to at least one embodiment, step B) includes at least once, for example, prior or also after or between taking the measurement pictures:
B1) Analyzing illumination conditions of the target with the light source being turned off by taking one or a plurality of reference images. Said illumination conditions can result from the at least one exterior illumination source.

According to at least one embodiment, step C) includes:
C1) Subtracting the illumination conditions present in the reference image from the measurement pictures. Hence, 3D reconstruction may also be done when the target is illuminated by the at least one exterior illumination source.

According to at least one embodiment, step B) includes:
B2) Estimating a three-dimensional representation of a scene that comprises the target, the estimation is done within and/or out of a field of view of the image sensor. Accordingly, information about reflective surfaces next to the target can be obtained, for example, prior to taking the measurement pictures.

According to at least one embodiment, a foreground mask and/or a background mask is computed, for example, in the case of the scene relighting application.

According to at least one embodiment, step C) includes, for example, prior or after taking the measurement pictures in step B):
C2) Estimating an influence of the reflective surfaces next to the target. Hence, suitable reflective surfaces may specifically be addressed in method step B), or unsuitable surfaces may be omitted from 3D reconstruction.

According to at least one embodiment, step B) comprises:

Taking a low-light image of the target with the light source being switched off.

According to at least one embodiment, an emission angle between an optical axis of the image sensor and all or a majority or some of the emission directions is at least 30° or is at least 45° or is at least 55°. Alternatively or additionally, this angle is at most 75° or is at most 70° or is at most 65°. Said angle may refer to a direction of maximum intensity of the respective emission direction.

According to at least one embodiment, for all or a majority or some of the emission directions an emission angle width per emission direction is at least 15° or is at least 25°.Alternatively or additionally, said angle is at most 45° or is at most 35°. Said angle may refer to a full width at half maximum, FWHM for short.

It is possible that the same emission parameters apply for all the emission directions or that the emission parameters intentionally differ between the emission directions.

According to at least one embodiment, the radiation emitted into the emission directions is emitted out of a field of view of the image sensor. That is, the radiation does not provide direct lighting of the target.

According to at least one embodiment, there are at least six or at least 10 or at least 12 of the emission directions. Alternatively or additionally, there are at most 60 or at most 30 or at most 20 or at most 18 of the emission directions. For example, the number of emission directions is between 12 and 16 inclusive.

According to at least one embodiment, the light source comprises one light-emitting unit for each one of the emission directions. The light-emitting unit can be an emitter with one fixed emission characteristics or can also be an emitter with adjustable emission characteristics, like an RGB emitter, for example. It is possible that all light-emitting units are of the same construction, that is, of the same emission characteristics, or that there are light-emitting units with intentionally different emission characteristics.

According to at least one embodiment, positions of the light-emitting units relative to one another are fixed. That is, the light-emitting units cannot be moved relative to one another in intended use of the picture recording arrangement. Further, the light-emitting units can preferably not be moved relative to the image sensor in intended use of the picture recording arrangement.

According to at least one embodiment, the light source comprises exactly one light-emitting unit or less light-emitting units than emission directions. The one light-emitting unit or at least one or some or all of the less light-emitting units than emission directions can move and/or rotate relative to the image sensor. It is possible that during moving and/or rotating a distance between the image sensor and the one light-emitting unit or the less light-emitting units than emission directions is kept constant or virtually constant.

According to at least one embodiment, a relative position of the exactly one light-emitting unit or the less light-emitting units than emission directions relative to the image sensor is kept constant. In this case, an orientation of the respective emission direction relative to the optical axis of the image sensor can change during step B). In other words, the one light-emitting unit or at least one of the less light-emitting units than emission directions can be configured to rotate in step B), wherein a rotational axis can run through a center of gravity of the respective light-emitting unit.

According to at least one embodiment, the light-emitting units are arranged in a circular manner, seen in top view of the image sensor. For example, the image sensor may be arranged within the circle the light-emitting units are arranged on or also out of said circle. The emission directions can be oriented inwards.

According to at least one embodiment, the light source comprises an additional light-emitting unit configured for direct lighting of the target. It is possible that said additional light-emitting unit is used in other situations and/or applications than the light-emitting units for indirect lighting. Hence, it is possible that both direct and indirect lighting may be addressed with the picture recording arrangement simultaneously or independently of one another.

According to at least one embodiment, the method is performed indoor. Thus, the intended use case is in rooms and not in the open environment, in particular not in natural day light.

According to at least one embodiment, in step B) the light source emits a series of photo flashes.

According to at least one embodiment, a distance between the picture recording arrangement and the target is at least 0.2 m or at least 0.3 m or is at least 1 m. Alternatively or additionally, said distance is at most 10 m or is at most 6 m or is at most 3 m. In other words, the picture recording arrangement and the target are intentionally relatively close to one another.

According to at least one embodiment, the light source is configured to independently emit a plurality of beams having different colors along all or some or a majority of the emission directions. Thus, RGB light may be provided.

According to at least one embodiment, the light source is configured to emit only a single beam of light along at least some of the emission directions. Thus, the light source can have a single, fix color to be emitted. In this case, ‘color’ may refer to a specific coordinate in the CIE color table or also to non-visible radiation like near-IR radiation.

According to at least one embodiment, the light source comprises one or a plurality of emitters for non-visible radiation, like near-IR radiation. It is possible that there is only one common emitter for non-visible radiation or that there is one emitter for non-visible radiation per emission direction.

According to at least one embodiment, the picture recording arrangement comprises a 3D-sensor. By means of the 3D-sensor, the picture recording arrangement can obtain three-dimensional information of the scene, for example, prior to step B). The 3D-sensor can be, for example, based on a stereo camera set-up, on a time-of-flight set-up or on a reference pattern analyzing set-up.

According to at least one embodiment, the picture recording arrangement is a single device, like a single mobile device, including the image sensor as well as the light source and optionally the at least one additional light-emitting unit, the at least one emitter for non-visible radiation and/or the at least one 3D-sensor.

According to at least one embodiment, the picture recording arrangement is a mobile phone, like a smart phone.

A picture recording arrangement is additionally provided. The picture recording arrangement is controlled, for example, by means of the method as indicated in connection with at least one of the above-stated embodiments. Features of the picture recording arrangement are therefore also disclosed for the method and vice versa.

In at least one embodiment, the picture recording arrangement is a mobile device and comprises an image sensor, a light source and a processing unit, wherein
the light source is configured to illuminate a target along different emission directions,
the image sensor is configured to take a plurality of measurement pictures along the emission directions, wherein per measurement picture only a subset of the emission directions is served by the light source,
the processing unit is configured to reconstruct a three-dimensional shape of the target from the measurement pictures.

### BRIEF DESCRIPTION OF THE DRAWINGS

A method and a picture recording arrangement described herein are explained in greater detail below by way of exemplary embodiments with reference to the drawings. Elements which are the same in the individual figures are indicated with the same reference numerals. The relationships between the elements are not shown to scale, however, but rather individual elements may be shown exaggeratedly large to assist in understanding.

FIG. 1 is a schematic side view of an exemplary embodiment of a method using a picture recording arrangement described herein;

FIG. 2 is a schematic front view of the method of FIG. 1;

FIG. 3 is a schematic block diagram of an exemplary embodiment of a method described herein;

FIGS. 4 and 5 are schematic representations of method steps of an exemplary embodiment of a method described herein;

FIG. 6 is a schematic representation of the emission characteristics of a light-emitting unit for exemplary embodiments of picture recording arrangements described herein;

FIGS. 7 and 8 are schematic top views of exemplary embodiments of picture recording arrangements described herein;

FIGS. 9 and 10 are schematic sectional views of light-emitting units for exemplary embodiments of picture recording arrangements described herein; and

FIGS. 11 and 12 are schematic top views of exemplary embodiments of picture recording arrangements described herein.

### DETAILED DESCRIPTION OF ILLUSTRATIVE EMBODIMENTS

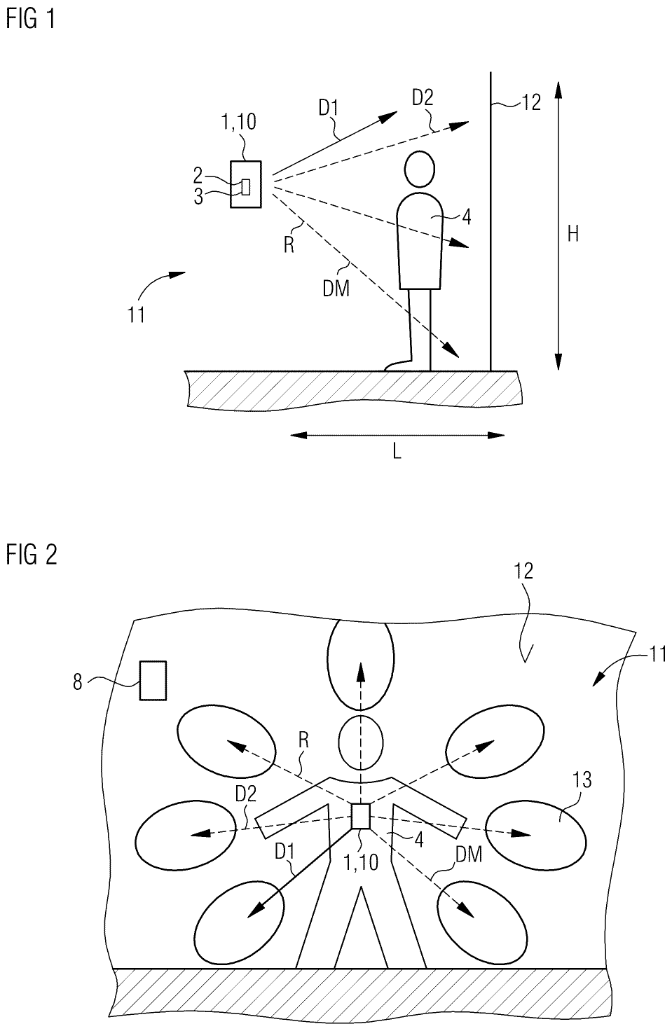

FIGS. 1 and 2 illustrate an exemplary embodiment of a method using a picture recording arrangement 1. The picture recording arrangement 1 is a mobile device 10 and comprises an image sensor 2 configured to take photos and/or videos. Further, the picture recording arrangement 1 comprises a light source 3. A user of the picture recording arrangement 1 is not shown in FIGS. 1 and 2.

For example, the picture recording arrangement 1 is used indoors to perform 3D reconstruction of a target 4 in a scene 11. The scene 11 represents surroundings of the target 4. For example, the target 4 is a person or an item, or a part of a person or of an item. For example, a distance L between the target 4 and the picture recording arrangement 1 is between 0.2 m and 3 m. It is possible that a size H of the target 4 is about 0.1 m to 2 m. The target 4 can be located in front of a wall 12 or also in a defined volume, like a box. The target 4 can be directly at the wall or can have some distance to the wall 12. However, there does not to be any background like the wall 12 as long as there are reflective surfaces which could also be realized by objects between the picture recording arrangement 1 and the target 4.

The light source 3 is configured to emit radiation R, like visible light and/or infrared radiation, along a plurality of emission directions D1 . . . DM. Thus, there are M emission directions. For example, M is between ten and 20 inclusive. By means of the light source 3, for example, for each one of the emission directions D1 . . . DM one illuminated area 13 is present next to the target 4 in particular out of a field of view of the image sensor 2. Thus, the light source 3 can provide indirect lighting. The emission of the radiation R along the emission directions D1 . . . DM can be adjusted by means of a processing unit of the picture recording arrangement 1. This is symbolized in FIGS. 1 and 2 in that the actually served emission direction D1 is drawn as a solid line while the emission directions D2 . . . DM to be served by the light source 3 later are drawn as dashed lines.

For example, in the room the picture recording arrangement 1 and the target 4 are located there is no lighting or only very weak light in order not to hamper data acquisition for 3D reconstruction. However, there can also be an illumination source, like a luminaire 8, that provides in particular weak lighting. The luminaire 8 may provide only light of a specific color that may be filtered out by the image sensor 2.

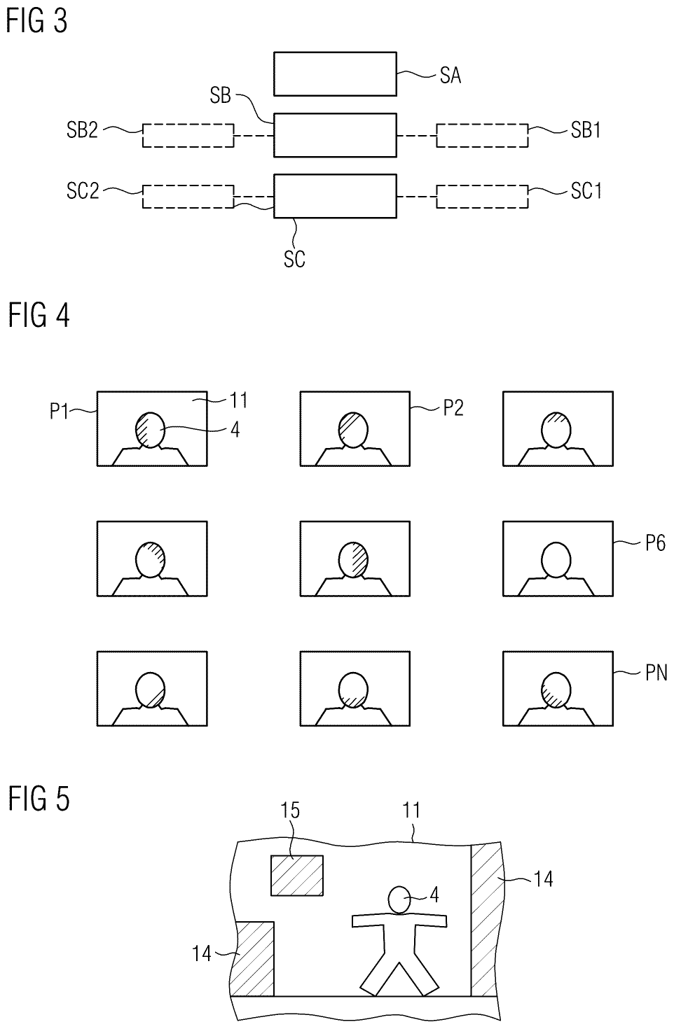

An example of the method to achieve 3D reconstruction of the target 4 is schematically illustrated in connection with FIG. 3.

In method step SA, the picture recording arrangement 1 comprising the image sensor 2 and the light source 3 is provided, the light source 3 is configured to illuminate the scene 11 comprising the target 4 along the different emission directions D1 . . . DM.

In method step SB, for example, at least one measurement picture P1 . . . PN is taking for each one of the emission directions D1 . . . DM, wherein per measurement picture P1 . . . PN the light source 3 emits radiation R only along a subset of the emission directions D1 . . . DM. Thus, a series of measurement pictures P1 . . . PN is produced with at least one or exactly one selected emission direction D1 . . . DM is served by the light source 3 per measurement picture P1 . . . PN. For example, step SB is done under low-light conditions or dark room conditions so that there is no or no significant illumination source to illuminate the target 4 despite the light source 4 of the picture recording arrangement 1. It is possible to omit emission directions from taking measurement pictures, for example, to save time or to avoid unsuitable illumination conditions.

This is also illustrated in FIG. 4 where it is shown that a series of the measurement pictures P1 . . . PN is taken. For example, each measurement pictures P1 . . . PN is taken with different illumination conditions, that is, for example, with a different one of the emission directions D1 . . . DM being served by the light source 2. Hence, the target 4 can be indirectly illuminated from different directions. This is symbolized in FIG. 4 by the different hatchings.

It is further possible that at least one of the measurement pictures P6 is taken by direct illumination, like a conventional photo flash, or without any lighting provided by the light source 3.

In method step SC, a reconstruction of a three-dimensional shape of the target 4 is done based on the previously taken measurement pictures P1 . . . PN.

In case that step SB is done while the target 4 is in particular weakly illuminated by the exterior illumination source 8, step SB may include a step SB1 in which the illumination conditions of the target 4 with the light source 3 being turned off are analyzed, for example, by taking a reference image. The reference image may correspond to the picture P6 in FIG. 4, for example.

Correspondingly, step SC can include step SC1 in which subtracting the illumination conditions present in the reference image from the measurement pictures P1 . . . PN is done. Accordingly, disturbing effects due to the exterior illumination source 8 can be eliminated or at least reduced.

Additionally or alternatively to steps SB1, SC1, the method can include a step SB2 in which estimating a three-dimensional representation of the scene 11 in which the target 4 is located within and/or out of a field of view 22 of the image sensor 2 is done. This estimation may be done by a 3D sensor included in the picture recording arrangement 1. Further, algorithms may be used like graphics rendering to obtain knowledge about characteristics of the nearby surfaces.

As a possible step SB3, a foreground mask and/or a background mask can be generated.

Consequently, step SC can include a step SC2 in which an influence of reflective surfaces 14 next to the target 4 on the measurement pictures P1 . . . PN and/or on the 3D reconstruction is estimated. It may also be recognized if there are unsuitable surfaces 15 like mirrors or the like which may hamper 3D reconstruction if illuminated.

Step SC could also include to analyze the measurement pictures P1 . . . PN if there are any pictures not suitable for 3D reconstruction so that such pictures may be discarded.

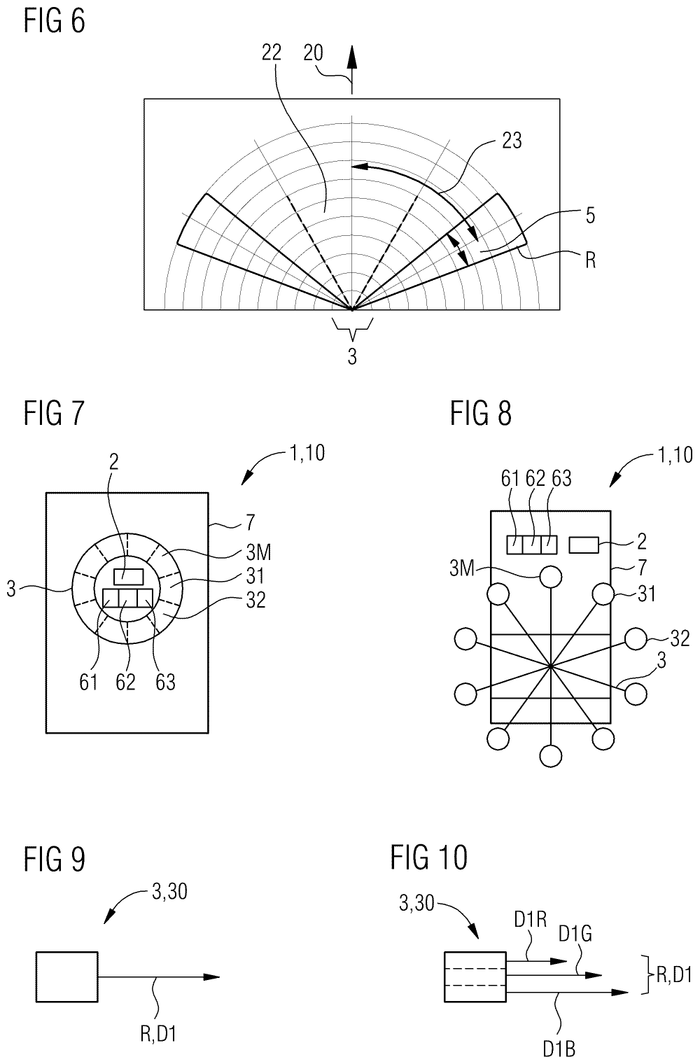

In FIG. 6, exemplary parameters of the emission directions D1 . . . DM are illustrated. For example, an angle 23 between an optical axis 20 of the image sensor 2 and the emission directions D1 . . . DM is about 60°. An emission angle width 5 of the emission directions D1 . . . DM may be about 30° in each case. Thus, no or virtually no radiation R is emitted by the light source 3 into the field 22 of view of the image sensor 2.

In FIGS. 7 and 8, exemplary embodiments of the picture recording arrangement 1 are shown. In both cases, the picture recording arrangement 1 is a mobile device 10, like a smartphone.

The light source 3 comprises a plurality of light-emitting units 31 . . . 3M. The light-emitting units 31 . . . 3M can be light-emitting diodes, LEDs for short. It is possible that the light-emitting units 31 . . . 3M are arranged in a circular manner, that is, on a circle. Because a distance between the light-emitting units 31 . . . 3M is very small compared with a distance between the illuminated areas 13, compare FIG. 2, it is not necessary that an arrangement order of the light-emitting units 31 . . . 3M corresponds to an arrangement order of the illuminated areas 13. Hence, it is alternatively also possible for the light-emitting units 31 . . . 3M to be arranged in a matrix, for example.

If the light-emitting units 31 . . . 3M are arranged on a circle, it is possible that the respective emission directions D1 . . . DM associated with the light-emitting units 31 . . . 3M can point inwards, that is, can cross a center of the circle.

Moreover, the picture recording arrangement 1 includes the at least one image sensor 2, for example, a CCD chip. Optionally, the picture recording arrangement 1 can include at least one of an additional light-emitting unit 61, an emitter 62 for non-visible radiation or a 3D-sensor 63. Further, the picture recording arrangement 1 comprises a processing unit 7 configured to perform the method described above. The processing unit 7 can be a main board or an auxiliary board of the picture recording arrangement 1.

According to FIG. 7, the light source 3 is integrated in a casing of the picture recording arrangement 1. The light-emitting units 31 . . . 3M are arranged around the image sensor 2. Optionally, the at least one of the additional light-emitting unit 61, the emitter 62 for non-visible radiation or the 3D-sensor 63 can also be located within the arrangement of the light-emitting units 31 . . . 3M, seen in top view of the image sensor 2.

Other than shown in FIG. 7, the at least one of the additional light-emitting unit 61, the emitter 62 for non-visible radiation or the 3D-sensor 63 as well as the image sensor 2 can be located outside of the arrangement of the light-emitting units 31 . . . 3M. as illustrated in FIG. 8.

Moreover, in FIG. 8 it is shown that the light-emitting units 31 . . . 3M are arranged in a spider-like manner. In this case, the arrangement of the light-emitting units 31 . . . 3M can protrude from the casing, but it can also be completely within the casing, seen in top view of the image sensor 2 and other than shown in FIG. 8.

Thus, it is possible that the light-source 3 can be an external unit mounted, like clamped or glued, on the casing. An electrical connection between the casing and the light-source 3 can be done by a USB type C connection, for example.

Otherwise, the same as to FIGS. 1 to 6 may also apply to FIGS. 7 and 8, and vice versa.

In FIG. 9, one exemplary light-emitting unit 31 of the light source 3 is illustrated. In this case, the light-emitting unit 31 has only one channel, that is, is configured to emit along the assigned emission direction D1 with a fixed color, for example. Said color is white light, for example.

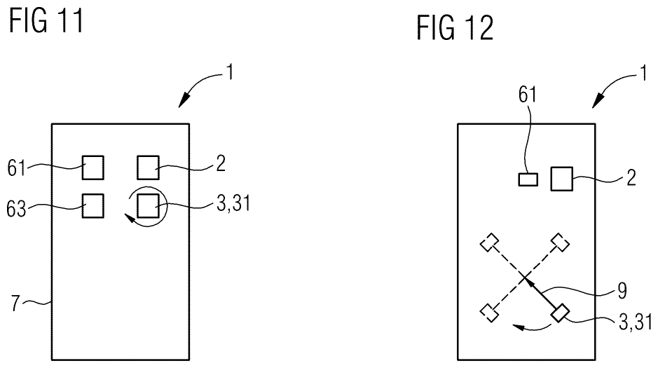

Contrary to that, according to FIG. 10 the light-emitting unit 31 comprises three color channels for red, green and blue light, for example, or also white light of different correlated color temperatures. Thus, for example, three beams D1R, D1G, D1B are emitted along the assigned emission direction D1 to form the radiation R. The three-color channels are preferably electrically addressable independent of one another so that an emission color of the light-emitting unit 31 can be tuned. For example, each color channel is realized by an own LED chip as the respective light emitter.

The light-emitting units 31 of FIGS. 9 and 10 can be used in all embodiments of the picture recording arrangement 1, also in combination with each other.

Otherwise, the same as to FIGS. 1 to 8 may also apply to FIGS. 9 and 10, and vice versa.

In FIGS. 11 and 12, further exemplary embodiments of the picture recording arrangement 1 are shown. In both cases, the picture recording arrangement 1 is again a mobile device 10, like a smartphone, but includes only one light-emitting unit 31, contrary to the examples of FIGS. 7 and 8.

According to FIG. 11, the one light-emitting unit 31 of the light source 3 is in a fixed position. The light-emitting unit 31 is configured to be rotated. This may mean that either the complete light-emitting unit 31 can be rotated or that only part, like an optics, of the light-emitting unit 31, can be rotated in order to provide the different emission directions D1 . . . DM.

According to FIG. 12, the one light-emitting unit 31 is provided on an arm 9 that rotates with the light-emitting unit 31 around a center of rotation. Hence, the different emission directions D1 . . . DM can be provided by having the light source 3 on different rotational positions relative to the center of rotation.

Otherwise, the same as to FIGS. 1 to 10 may also apply to FIGS. 11 and 12, and vice versa.

The invention described here is not restricted by the description on the basis of the exemplary embodiments. Rather, the invention encompasses any new feature and also any combination of features, which includes in particular any combination of features in the patent claims, even if this feature or this combination itself is not explicitly specified in the patent claims or exemplary embodiments.

1.-19. (canceled)

20. A method for 3D reconstruction of a target, the method comprising:
providing a picture recording arrangement comprising an image sensor and a light source, the light source being configured to illuminate the target along different emission directions;
taking a plurality of measurement pictures along the emission directions, wherein per measurement picture only a subset of the emission directions is served by the light source; and
reconstructing a three-dimensional shape of the target from the measurement pictures,
wherein taking the plurality of measurement pictures comprises illuminating the target in an indirect manner so that at least some of the emission directions point next to the target and not onto the target, and
wherein orientations of the emission directions relative to the image sensor are fixed.

21. The method according to claim 20,
wherein taking the plurality of measurement pictures comprises illuminating the target by the light source exclusively in an indirect manner, and
wherein a diameter of the light source is at most 0.3 m, seen in top view of the image sensor.

22. The method according to claim 20,
wherein for each one of the emission directions exactly one measurement picture is taken, and per measurement picture exactly one of the emission directions is served by the light source, and
wherein a distance between the picture recording arrangement and the target is between 0.2 m and 6 m, inclusive.

23. The method according to claim 20,
wherein taking the plurality of measurement pictures comprises taking the pictures under low-light conditions so that there is no illumination source to illuminate the target despite the light source of the picture recording arrangement.

24. The method according to claim 20,
wherein taking the plurality of measurement pictures comprises taking the pictures while the target is illuminated by an exterior illumination source,
wherein taking the plurality of measurement pictures includes, prior to taking the measurement pictures,
analyzing illumination conditions of the target with the light source being turned off by taking a reference image, and
wherein reconstructing the three-dimensional shape of the target includes
subtracting the illumination conditions present in the reference image from the measurement pictures.

25. The method according to claim 20,
wherein taking the plurality of measurement pictures includes
estimating a three-dimensional representation of a scene in which the target is located within and/or out of a field of view of the image sensor, and
wherein reconstructing the three-dimensional shape of the target includes
estimating an influence of reflective surfaces next to the target.

26. The method according to claim 20,
wherein an emission angle between an optical axis of the image sensor and at least some of the emission directions is between 30° and 75° inclusive,
wherein, for at least some of the emission directions, an emission angle width per emission direction is between 15° and 45°, inclusive, and
wherein radiation emitted into the emission directions is emitted out of a field of view of the image sensor.

27. The method according to claim 20,
wherein there are at least six and at most 60 of the emission directions.

28. The method according to claim 20,
wherein the light source comprises one light-emitting unit for each one of the emission directions, positions of the light-emitting units relative to one another being fixed,
wherein the light-emitting units are arranged in a circular manner, seen in top view of the image sensor.

29. The method according to claim 20,
wherein the light source comprises one or less light-emitting units than emission directions, the one or less light-emitting units than the emission directions moving or rotating relative to the image sensor.

30. The method according to claim 20,
wherein the light source comprises an additional light-emitting unit configured for direct lighting of the target.

31. The method according to claim 20,
wherein the light source independently emits a plurality of beams having different colors along at least some of the emission directions.

32. The method according to claim 20,
wherein the light source emits only a single beam of light along at least some of the emission directions.

33. The method according to claim 20,
wherein the light source comprises an emitter for non-visible radiation.

34. The method according to claim 33,
wherein, for all or for some of the emission directions, there is one emitter for near-infrared radiation per emission direction of the emission directions.

35. The method according to claim 20,
wherein the picture recording arrangement comprises a 3D-sensor.

36. The method according to claim 20,
wherein the picture recording arrangement is a single mobile device including the image sensor and the light source.

37. The method according to claim 20,
wherein the picture recording arrangement is a smart phone.

38. A mobile device comprising:
an image sensor;
a light source; and
a processor,
wherein the light source is configured to illuminate a target along different emission directions,
wherein the image sensor is configured to take a plurality of measurement pictures along the emission directions,
wherein, per measurement picture, only a subset of the emission directions is served by the light source,
wherein the processor is configured to reconstruct a three-dimensional shape of the target from the measurement pictures,
wherein the picture recording arrangement is configured such that the target is illuminated in an indirect manner so that at least some of the emission directions point next to the target and not onto the target, and out of a field of view of the image sensor, and
wherein orientations of the emission directions relative to the image sensor are fixed.

39. A method for 3D reconstruction of a target, the method comprising:
providing a single mobile device comprising an image sensor and a light source, the light source being configured to illuminate the target along different emission directions;
taking a plurality of measurement pictures along the emission directions, wherein, per measurement picture, only a subset of the emission directions is served by the light source; and
reconstructing a three-dimensional shape of the target from the measurement pictures,
wherein taking the plurality of measurement pictures comprises illuminating the target in an indirect manner so that at least some of the emission directions point next to the target and not onto the target, and out of a field of view of the image sensor, and
wherein orientations of the emission directions relative to the image sensor are fixed.
